(19) United States
(12) Patent Application Publication
(10) Pub. No.: US 2015/0120019 A1
(43) Pub. Date: Apr. 30, 2015

(54) SYSTEM AND METHOD FOR PROVIDING LIFESTYLE RECOMMENDATIONS

(71) Applicant: JayBird LLC, Salt Lake City, UT (US)

(72) Inventors: BEN WISBEY, Canberra (AU); DAVID SHEPHERD, Canberra (AU); HAGEN DIESTERBECK, Little Bay (NZ)

(73) Assignee: JAYBIRD LLC, Salt Lake City, UT (US)

(21) Appl. No.: 14/140,418

(22) Filed: Dec. 24, 2013

Related U.S. Application Data
(63) Continuation-in-part of application No. 14/137,734, filed on Dec. 20, 2013.
Application No. 14/137,734 is a continuation-in-part of application No. 14/062,815, filed on Oct. 24, 2013.

(51) Int. Cl. G09B 5/02

(52) U.S. Cl. CPC G09B 5/02
USPC 700/91

(57) ABSTRACT

A system for providing a lifestyle recommendation includes an apparatus for providing a lifestyle recommendation. The apparatus includes a movement monitoring module that monitors a movement to detect an activity and create an activity score associated with the movement. The apparatus also includes a fatigue level module that detects a fatigue level. In addition, the apparatus includes a lifestyle recommendation module that provides a lifestyle recommendation based on the activity, the activity score, and the fatigue level.

### CROSS-REFERENCE TO RELATED APPLICATIONS

This application is a continuation-in-part of and claims the benefit of U.S. patent application Ser. No. 14/137,734, filed Dec. 20, 2013, titled “System and Method for Providing a Smart Activity Score,” which is a continuation-in-part of U.S. patent application Ser. No. 14/062,815, filed Oct. 24, 2013, titled “Wristband with Removable Activity Monitoring Device.” The contents of both the Ser. No. 14/137,734 application and the Ser. No. 14/062,815 application are incorporated herein by reference.

### TECHNICAL FIELD

The present disclosure relates generally to fitness monitoring devices, and more particularly to a system and method for providing lifestyle recommendations.

### DESCRIPTION OF THE RELATED ART

Previous generation fitness tracking devices generally enabled only a tracking of activity that accounts for total calories burned. Currently available fitness tracking devices now add functionality that tracks activity based on universal metabolic equivalent tasks. One issue is that currently available fitness tracking devices do not provide lifestyle recommendations based on a user's performance state, or recovery state, in a scientific, user-specific way to provide the user with lifestyle recommendations that will position the user in an optimal performance (or recovery) zone with respect to the user's fatigue level. Another issue is that currently available solutions do not provide a prediction for the user's fatigue level based on the lifestyle recommendation.

### BRIEF SUMMARY OF THE DISCLOSURE

In view of the above drawbacks, there exists a long-felt need for fitness monitoring devices that detect a fatigue level in a scientific way and provide a user-specific lifestyle recommendation based on the fatigue level and the user's activity. Further, there is a need for fitness monitoring devices that predict how the lifestyle recommendation will affect the user's overall fatigue and recovery response, and that position the user in an optimal performance zone.

Embodiments of the present disclosure include systems and methods for providing lifestyle recommendations.

One embodiment involves an apparatus for providing a lifestyle recommendation. The apparatus includes a movement monitoring module that monitors a movement to detect an activity and create an activity score associated with the movement. The apparatus also includes a fatigue level module that detects a fatigue level. In addition, the apparatus includes a lifestyle recommendation module that provides a lifestyle recommendation based on the activity, the activity score, and the fatigue level.

The lifestyle recommendation, in one embodiment, includes a recommended activity. In one case, the recommended activity includes at least one of recommended activity type, a recommended activity intensity, a recommended activity duration, a recommended activity time, and a recommended activity periodicity. In a further embodiment, the lifestyle recommendation includes a recommended activity score. The lifestyle recommendation, in one instance, includes a recommended fatigue level. In another embodiment, the lifestyle recommendation maintains the fatigue level at an optimal level.

The apparatus for providing a lifestyle recommendation, in one embodiment, also includes a fatigue source detection module that detects a source of the fatigue level. In one embodiment, the apparatus also includes a fatigue level prediction module that provides a fatigue level prediction based on the lifestyle recommendation. The fatigue level prediction, in one case, is based on input from a user. In various embodiments, at least one of the movement monitoring module, the fatigue level module, and the lifestyle recommendation module is embodied in a wearable sensor.

One embodiment of the present disclosure involves a method for providing a lifestyle recommendation. The method includes monitoring a movement to detect an activity and create an activity score associated with the movement. The method also includes detecting a fatigue level. In addition, the method includes providing a lifestyle recommendation based on the activity, the activity score, and the fatigue level.

The lifestyle recommendation, in one embodiment, includes a recommended activity. In one case, the recommended activity includes a recommended activity type, and the recommended activity type is one of sleep, exercise, work, and recovery. In a further embodiment, the lifestyle recommendation includes a recommended activity score. The lifestyle recommendation, in one instance, includes a recommended fatigue level. In another embodiment, the lifestyle recommendation maintains the fatigue level at an optimal level.

The method for providing a lifestyle recommendation, in one embodiment, also includes detecting a source of the fatigue level. In one embodiment, the method includes providing a fatigue level prediction based on the lifestyle recommendation. The fatigue level prediction, in one case, is based on input from a user. In various embodiments, at least one of the operations of monitoring the movement, detecting the fatigue level, and providing the lifestyle recommendation includes using a sensor configured to be attached to the body of the user.

One embodiment of the disclosure includes a system for providing a lifestyle recommendation. The system includes a processor and at least one computer program residing on the processor. The computer program is stored on a non-transitory computer readable medium having computer executable program code embodied thereon. The computer executable program code is configured to monitor a movement to detect an activity and create an activity score associated with the movement. The computer executable program code is also configured to detect a fatigue level. In addition, the computer executable program code is configured to provide a lifestyle recommendation based on the activity, the activity score, and the fatigue level.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates a cross-sectional view of a wristband and electronic modules of an example activity monitoring device.

FIG. 2 illustrates a perspective view of an example activity monitoring device.

FIG. 3 illustrates a cross-sectional view of an example assembled activity monitoring device.

FIG. 4 illustrates a side view of an example electronic capsule.

FIG. 5 illustrates a cross-sectional view of an example electronic capsule.

FIG. 6 illustrates perspective views of wristbands as used in one embodiment of the disclosed activity monitoring device.

FIG. 7 illustrates an example system for providing a lifestyle recommendation.

FIG. 8 illustrates an example apparatus for providing a lifestyle recommendation.

FIG. 9 illustrates another example apparatus for providing a lifestyle recommendation.

FIG. 10A is an operational flow diagram illustrating an example method for providing a lifestyle recommendation.

FIG. 10B is an example metabolic loading table

FIG. 10C is an example activity intensity library.

FIG. 11 is an operational flow diagram illustrating an example method for providing a lifestyle recommendation including detecting a source of the fatigue level and providing a fatigue level prediction.

FIG. 12 illustrates an example computing module that may be used to implement various features of the systems and methods disclosed herein.

The figures are not intended to be exhaustive or to limit the disclosure to the precise form disclosed. It should be understood that the disclosure can be practiced with modification and alteration, and that the disclosure can be limited only by the claims and the equivalents thereof.

### DETAILED DESCRIPTION

The present disclosure is directed toward systems and methods for providing lifestyle recommendations. The disclosure is directed toward various embodiments of such systems and methods. In one such embodiment, the systems and methods are directed to a device that provides a lifestyle recommendation. According to some embodiments of the disclosure, the device may be an electronic capsule embedded in and removable from an attachable device that may be attached to a user. In one embodiment, the attachable device is a wristband. In another embodiment, the attachable device includes an activity monitoring device.

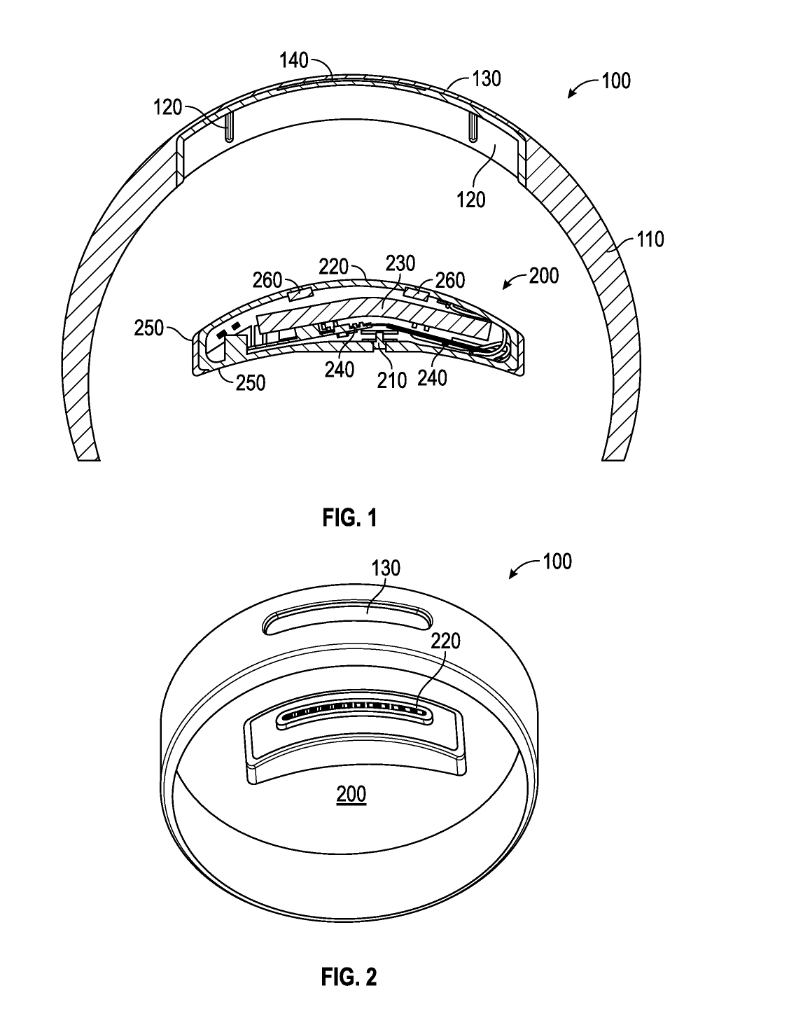

FIG. 1 is a diagram illustrating a cross-sectional view of an example embodiment of an activity monitoring device. Referring now to FIG. 1, an activity monitoring device comprises electronic capsule 200 and wristband 100. Electronic capsule 200 comprises wrist biosensor 210, finger biosensor 220, battery 230, one or more logic circuits 240, and casing 250.

In some embodiments, one or more logic circuits 240 comprise an accelerometer, a wireless transmitter, a wireless receiver, and circuitry. Logic circuits 240 may further comprise a gyroscope. Logic circuits 240 may be configured to process electronic input signals from biosensors 210, 220 and the accelerometer, store the processed signals as data, and output the data using the wireless transmitter. The transmitter is configured to communicate using available wireless communications standards (e.g., over communication medium 704). For example, in some embodiments, the wireless transmitter is a BLUETOOTH transmitter, a Wi-Fi transmitter, a GPS transmitter, a cellular transmitter, or a combination thereof. In an alternative embodiment, the wireless transmitter further comprises a wired interface (e.g. USB, fiber optic, HDMI, etc.) for communicating stored data.

Logic circuits 240 are electrically coupled to wrist biosensor 210 and finger biosensor 220. In addition, logic circuits 240 are configured to receive and process a plurality of electric signals from each of wrist biosensor 210 and finger biosensor 220. In some embodiments, the plurality of electric signals includes an activation time signal and a recovery time signal such that logic circuits 240 process the plurality of signals to calculate an activation recovery interval equal to the difference between the activation time signal and the recovery time signal. In some embodiments, the plurality of signals include electro-cardio signals from a heart, and logic circuits 240 process the electro-cardio signals to calculate and store an RR-interval, and the RR-interval is used to calculate and store a heart rate variability (HRV) value. In such embodiments, the RR-interval is equal to the delta in time between two R-waves, where the R-waves are the electro-cardio signals generated by a ventricle contraction in the heart.

In some embodiments, logic circuits 240 further detect and store metrics such as the amount of physical activity, sleep, or rest over a recent period of time, or the amount of time without physical activity over a recent period of time. Logic circuits 240 may then use the HRV, or the HRV in combination with these metrics, to calculate a fatigue level. For example, logic circuits 240 may detect the amount of physical activity and the amount of sleep a user experienced over the last 48 hours, combine those metrics with the user's HRV, and calculate a fatigue level of between 1 and 10. In such an example, the fatigue level may indicate the user's physical condition and aptitude for further physical activity that day. The fatigue level may also be calculated on a scale of between 1 and 100, or any other scale or range. In addition, the fatigue level may be represented on a descriptive scale—for example, low, normal, and high.

Finger biosensor 220 and wrist biosensor 210, in some embodiments, are replaced or supplemented by a single biosensor. In one such embodiment, the single biosensor is an optical biosensor such as a pulse oximeter configured to detect blood oxygen saturation levels. The pulse oximeter may then output a signal to logic circuits 240 indicating a detected cardiac cycle phase, and logic circuits 240 may use cardiac cycle phase data to calculate an HRV value.

Wristband 100 comprises material 110 configured to encircle a human wrist. In one embodiment, wristband 100 is adjustable. Cavity 120 is notched on the radially inward facing side of wristband 100 and shaped to substantially the same dimensions as the profile of electronic capsule 200. In addition, aperture 130 is located in material 110 within cavity 120. Aperture 130 is shaped to substantially the same dimensions as the profile of finger biosensor 220. The combination of cavity 120 and aperture 130 is designed to detachably couple to electronic capsule 200 such that, when electronic capsule 200 is positioned inside cavity 120, finger biosensor 220 protrudes through aperture 130. Electronic capsule 200 may further comprise one or more magnets 260 configured to secure electronic capsule 200 to cavity 120. Magnets 260 may be concealed in casing 250. Cavity 120 may be configured to conceal magnets 260 when electric capsule 200 detachably couples to the combination of cavity 120 and aperture 130.

Wristband 100 may further comprise steel strip 140 concealed in material 110 within cavity 120. In this embodiment, when electronic capsule 200 is positioned within cavity 120, one or more magnets 260 are attracted to steel strip 140 and pull electronic capsule 200 radially outward with respect to wristband 100. The force provided by magnets 260 may detachably secure electronic capsule 200 inside cavity 120. In further embodiments, electronic capsule 200 is positioned inside cavity 120 and affixed using a form-fit, press-fit, snap-fit, friction-fit, VELCRO, or other temporary adhesion or attachment technology.

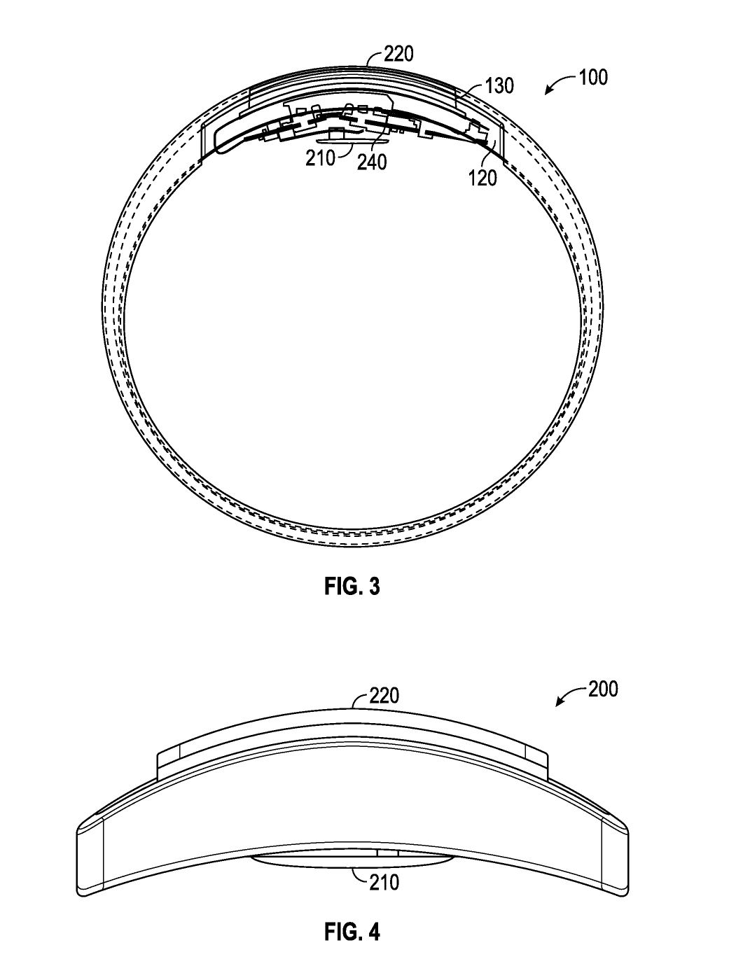

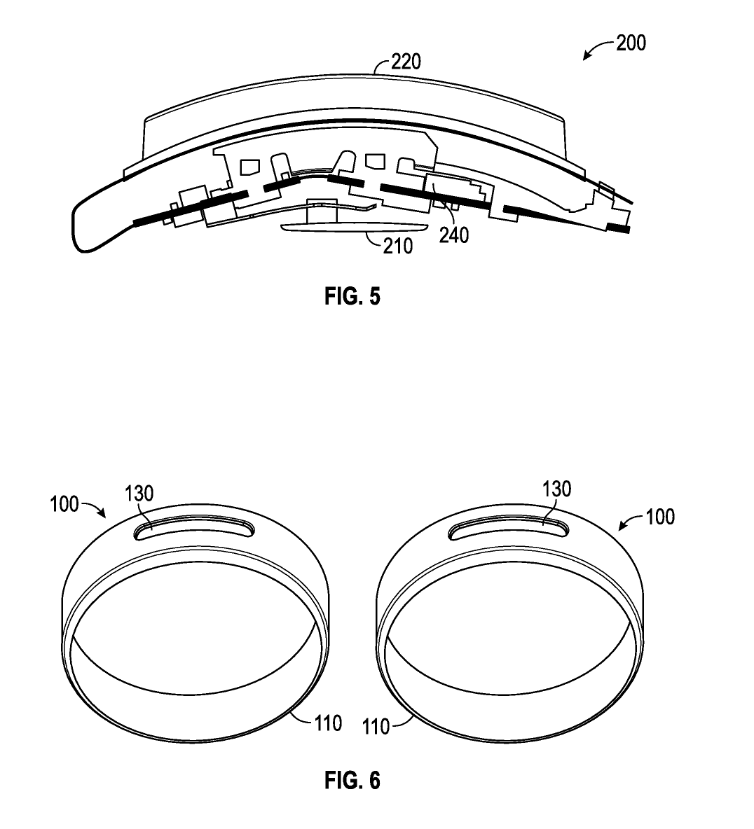

FIG. 2 illustrates a perspective view of one embodiment of the disclosed activity monitoring device, in which wristband 100 and electronic capsule 200 are unassembled. FIG. 3 illustrates a cross-sectional view of one embodiment of a fully assembled wristband 100 with removable athletic monitoring device. FIG. 4 illustrates a side view of electronic capsule 200 according to one embodiment of the disclosure. FIG. 5 illustrates a cross-sectional view of electronic capsule 200. FIG. 6 is a perspective view of two possible variants of wristband 100 according to some embodiments of the disclosure. Wristbands 100 may be constructed with different dimensions, including different diameters, widths, and thicknesses, in order to accommodate different human wrist sizes and different preferences.

In some embodiments of the disclosure, electronic capsule 200 is detachably coupled to a cavity on a shoe and/or a sock. In other embodiments, electronic capsule 200 is detachably coupled to sports equipment. For example, electronic capsule 200 may be detachably coupled to a skateboard, a bicycle, a helmet, a surfboard, a paddle boat, a body board, a hang glider, or other piece of sports equipment. In these embodiments, electronic capsule 200 is affixed to the sports equipment using magnets. In other embodiments, electronic capsule 200 is affixed using a form-fit, snap-fit, press-fit, friction-fit suction cup, VELCRO, or other technology that would be apparent to one of ordinary skill in the art.

In one embodiment of the disclosure, electronic capsule 200 includes an optical sensor such as a heart rate sensor or oximeter. In this embodiment, the optical sensor is positioned to face radially inward towards a human wrist when wristband 100 is fit on the human wrist. The optical sensor, in another example, is separate from electronic capsule 200, but is still detachably coupled to wristband 100 and electronically coupled to the circuit boards enclosed in electronic capsule 200. Wristband 100 and electronic capsule 200 may operate in conjunction with a system for providing a lifestyle recommendation.

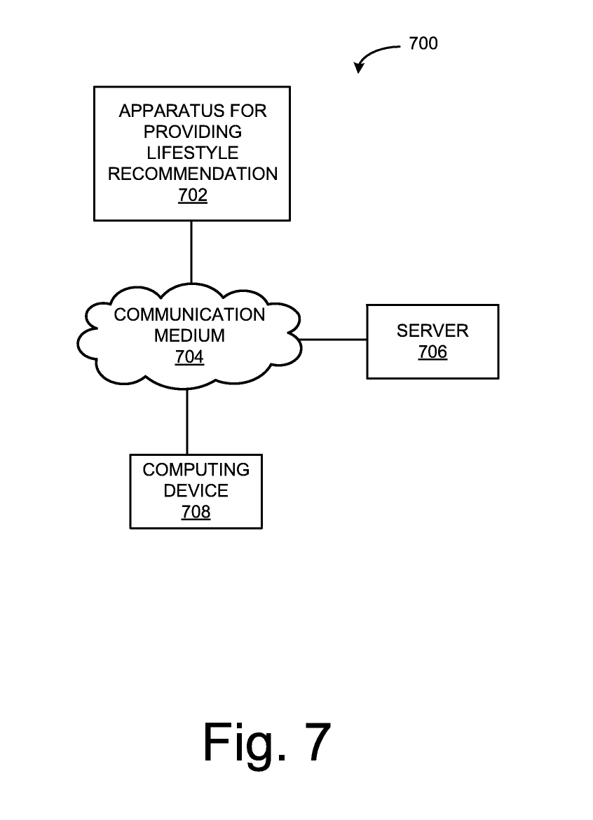

FIG. 7 is a schematic block diagram illustrating example system 700 for providing a lifestyle recommendation. System 700 includes apparatus for providing a lifestyle recommendation 702, communication medium 704, server 706, and computing device 708.

Communication medium 704 may be implemented in a variety of forms. For example, communication medium 704 may be an Internet connection, such as a local area network (“LAN”), a wide area network (“WAN”), a fiber optic network, internet over power lines, a hard-wired connection (e.g., a bus), and the like, or any other kind of network connection. Communication medium 704 may be implemented using any combination of routers, cables, modems, switches, fiber optics, wires, radio, and the like. Communication medium 704 may be implemented using various wireless standards, such as Bluetooth, Wi-Fi, 4G LTE, etc. One of skill in the art will recognize other ways to implement communication medium 704 for communications purposes.

Server 706 directs communications made over communication medium 704. Server 706 may be, for example, an Internet server, a router, a desktop or laptop computer, a smartphone, a tablet, a processor, a module, or the like. In one embodiment, server 706 directs communications between communication medium 704 and computing device 708. For example, server 706 may update information stored on computing device 708, or server 706 may send information to computing device 708 in real time.

Computing device 708 may take a variety of forms, such as a desktop or laptop computer, a smartphone, a tablet, a processor, a module, or the like. In addition, computing device 708 may be a processor or module embedded in a wearable sensor, a bracelet, a smart-watch, a piece of clothing, an accessory, and so on. For example, computing device 708 may be substantially similar to devices embedded in electronic capsule 200, which may be embedded in and removable from wristband 100, as illustrated in FIG. 1. Computing device 708 may communicate with other devices over communication medium 704 with or without the use of server 706. In one embodiment, computing device 708 includes apparatus 702. In various embodiments, apparatus 702 may be used to perform various processes described herein.

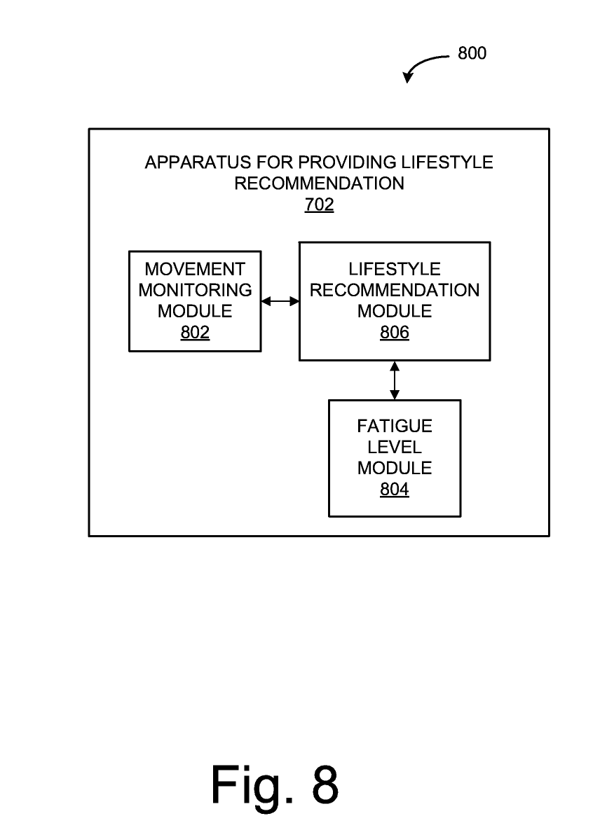

FIG. 8 is a schematic block diagram illustrating one embodiment of apparatus for providing a lifestyle recommendation 800. Apparatus 800 includes apparatus 702 with movement monitoring module 802, fatigue level module 804, and lifestyle recommendation module 806.

Movement monitoring module 802 monitors a movement to detect an activity and create an activity score associated with the movement. Movement monitoring module 802 will be described below in further detail with regard to various processes.

Fatigue level module 804 detects a fatigue level. Fatigue level module 804 will be described below in further detail with regard to various processes.

Lifestyle recommendation module 806 provides a lifestyle recommendation based on the activity, the activity score, and the fatigue level. Lifestyle recommendation module 806 will be described below in further detail with regard to various processes.

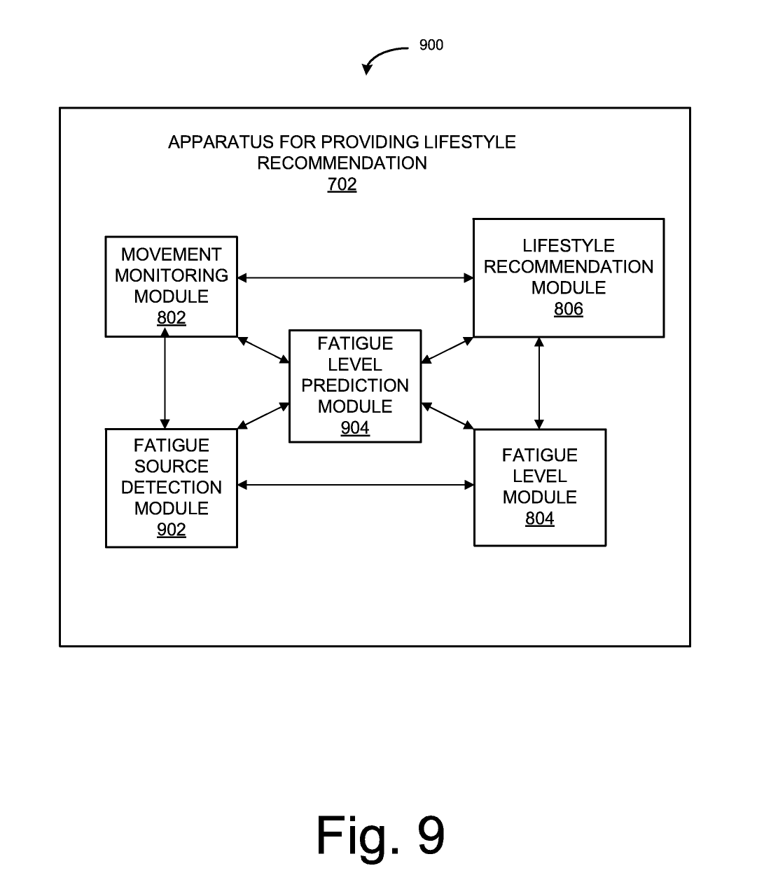

FIG. 9 is a schematic block diagram illustrating one embodiment of apparatus for providing a lifestyle recommendation 900. Apparatus 900 includes apparatus 702 with movement monitoring module 802, fatigue level module 804, and lifestyle recommendation module 806. Apparatus 900 also includes fatigue source detection module 902 that detects the source of the fatigue level. In addition, apparatus 900 includes fatigue level prediction module 904 that provides a fatigue level prediction based on the lifestyle recommendation. Fatigue source detection module 902 and fatigue level prediction module 904 will be described below in further detail with regard to various processes.

In one embodiment, at least one of movement monitoring module 802, fatigue level module 804, lifestyle recommendation module 806, fatigue source detection module 902, and fatigue level prediction module 904 is embodied in a wearable sensor, such as electronic capsule 200. In various embodiments, any of the modules described herein are embodied in electronic capsule 200 and connect to other modules described herein via communication medium 704.

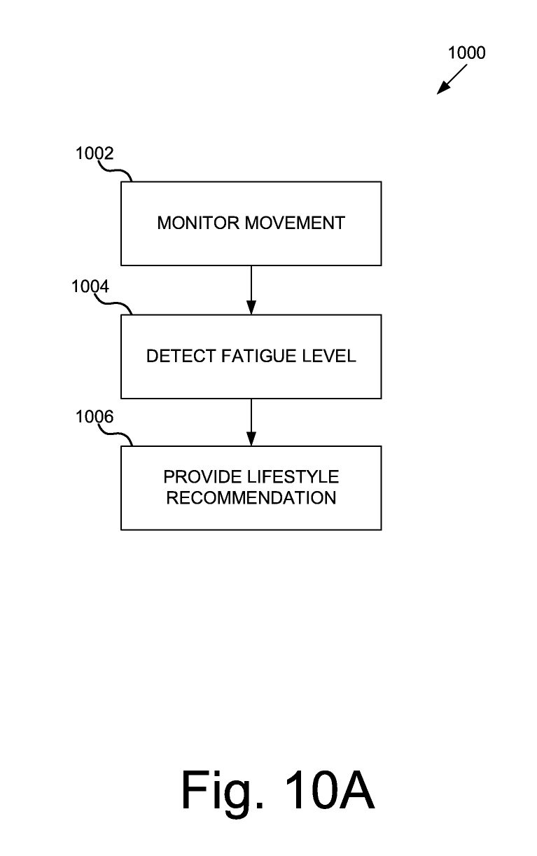

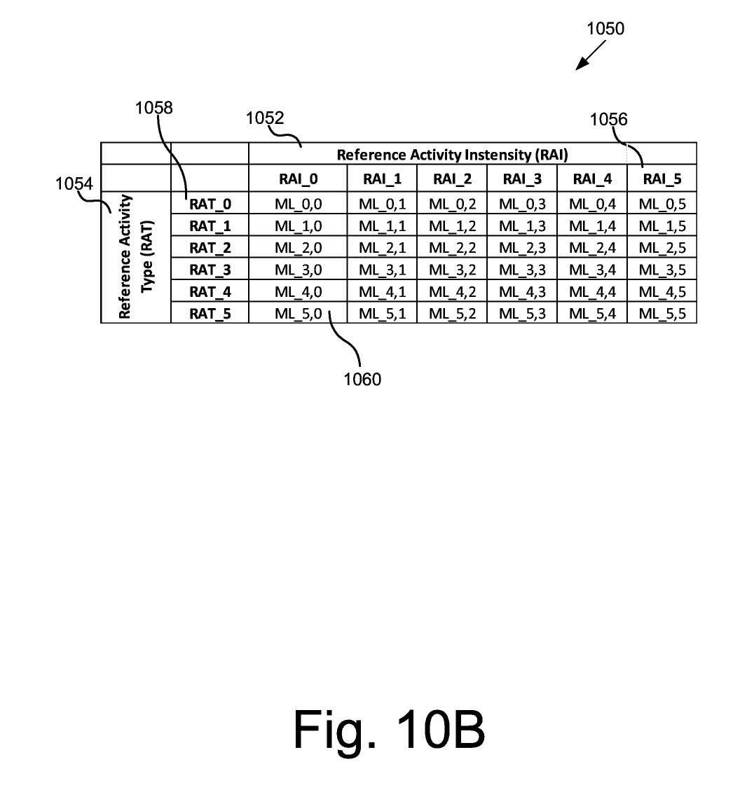

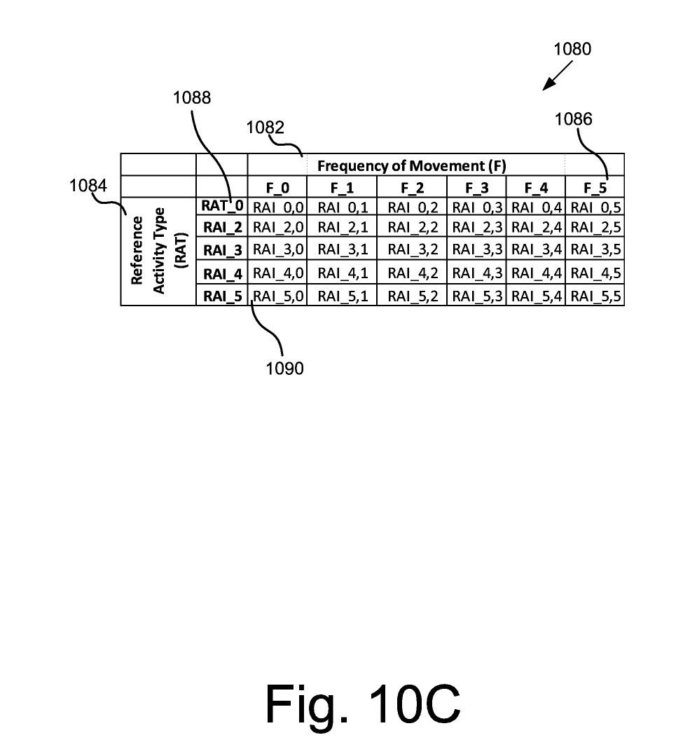

FIG. 10A is an operational flow diagram illustrating example method 1000 for providing a lifestyle recommendation in accordance with an embodiment of the present disclosure. The operations of method 1000 provide a lifestyle recommendation that is tuned specifically to a user's actual activity, as well as a to the user's scientifically detected fatigue level. This aids in providing lifestyle recommendations that are specifically tailored to the user. In one embodiment, apparatus 702, wristband 100, and electronic capsule 200 perform various operations of method 1000.

At operation 1002, method 1000 involves monitoring a movement to detect an activity and create an activity score associated with the movement. The activity, in one embodiment, includes an activity type, an activity intensity, and an activity duration, as will be described in detail below. In one embodiment of method 1000, the activity score is a metabolic activity score that is based on the movement and user information. The metabolic activity score, in one embodiment, is created from a set of metabolic loadings. The metabolic loadings may be determined by identifying a user activity type from a set of reference activity types and by identifying a user activity intensity from a set of reference activity intensities. In addition, the metabolic loadings may be determined based on information provided by a user (user information).

User information may include, for example, an individual's height, weight, age, gender, geographic and environmental conditions, and the like. The user may provide the user information by, for example, a user interface of computing device 708, or of electronic capsule 200. User information may be determined based on various Measurements—for example, measurements of the user's body-fat content or body type. In addition, the user information may be determined by an altimeter or GPS, which may be used to determine the user's elevation, weather conditions in the user's environment, etc. In one embodiment, apparatus 702 obtains user information from the user indirectly. For example, apparatus 702 may collect the user information from a social media account, from a digital profile, or the like.

The user information, in one embodiment, includes a user lifestyle selected from a set of reference lifestyles. Apparatus 702, in one instance, may prompt the user for information about the user's lifestyle (e.g., via a user interface). By way of example, apparatus 702 may prompt the user to determine how active the user's lifestyle is. Additionally, the user may be prompted to select the user lifestyle from the set of reference lifestyles. The reference lifestyles may include a range of lifestyles, for example, ranging from inactive, on one end, to highly active on the other end. In such a case, the set of reference lifestyles may include sedentary, mildly active, moderately active, and heavily active.

In one instance, the user lifestyle is determined from the user as an initial matter. For example, upon initiation, apparatus 702 may prompt the user to provide the user lifestyle. In a further embodiment, the user is prompted periodically to select the user lifestyle. In this fashion, the user lifestyle selected may be aligned with the user's actual activity level as the user's activity level varies over time. In another embodiment, the user lifestyle is updated without intervention from the user.

The metabolic loadings, in one embodiment, are numerical values and may represent a rate of calories burned per unit weight per unit time (e.g., having units of kcal per kilogram per hour). By way of example, the metabolic loadings may also be represented in units of oxygen uptake (e.g., in milliliters per kilogram per minute). In addition, the metabolic loadings may represent a ratio of the metabolic rate during activity (e.g., the metabolic rate associated with a particular activity type and/or activity intensity) to the metabolic rate during rest. The metabolic loadings, in one embodiment, are represented in a metabolic table, such as metabolic table 1050, illustrated in FIG. 10B. In one illustrative case, the metabolic loadings are specific to the user information. For example, the metabolic loadings may increase for a heavier user, or for an increased elevation, but may decrease for a lighter user or for a decreased elevation.

In one embodiment, the set of metabolic loadings is determined based on the user lifestyle, in addition to the other user information. For example, the metabolic loadings for a user with a heavily active lifestyle may differ from the metabolic loadings for a user with a sedentary lifestyle. In this fashion, the metabolic loadings may correspond with the user's particular characteristics.

In various embodiments, a device (e.g., computing device 708) or a module (e.g., electronic capsule 200 or a module therein) stores or provides the metabolic loadings. Moreover, the metabolic loadings may be maintained or provided by server 706 or over communication medium 704. In one embodiment, a system administrator provides the metabolic loadings based on a survey, publicly available data, scientifically determined data, compiled user data, or any other source of data. In some instances, movement monitoring module 802 performs the above-described operations. In various embodiments, movement monitoring module 802 includes a metabolic loading module and a metabolic table module that determine the metabolic loading associated with the movement.

In one embodiment, a metabolic table is maintained based on the user information. The metabolic table may include metabolic loadings, which may be based on the user information. In some cases, the metabolic table is maintained based on standard user information, in place of or in addition to the user information. The standard user information may comprise, for example, the average fitness characteristics of all individuals being the same age as the user, the same height as the user, etc. In another embodiment, instead of maintaining the metabolic table based on standard information, if the user has not provided user information, maintaining the metabolic table is delayed until the user information is obtained.

As illustrated in FIG. 10B, in one embodiment, the metabolic table is maintained as metabolic table 1050. Metabolic table 1050 may be stored in computing device 708 or apparatus 702, and may include information such as reference activity types (RATs) 1054, reference activity intensities (RAIs) 1052, and/or metabolic loadings (MLs) 1060. As illustrated in FIG. 10B, in one embodiment, RATs 1054 are arranged as rows 1058 in metabolic table 1050. Each of a set of rows 1058 corresponds to different RATs 1054, and each row 1058 is designated by a row index number. For example, the first RAT row 1058 may be indexed as RAT_{—}0, the second as RAT_{—}1, and so on for as many rows as metabolic table 1050 may include.

The reference activity types may include typical activities, such as running, walking, sleeping, swimming, bicycling, skiing, surfing, resting, working, and so on. The reference activity types may also include a catch-all category, for example, general exercise. The reference activity types may also include atypical activities, such as skydiving, SCUBA diving, and gymnastics. In one embodiment, the user defines a user-defined activity by programming computing device 708 (e.g., by an interface on electronic capsule 200) with information about the user-defined activity, such as pattern of movement, frequency of pattern, and intensity of movement. The typical reference activities may be provided, for example, by metabolic table 1050.

In one embodiment, reference activity intensities 1052 are arranged as columns 1056 in metabolic table 1050, with each column 1056 corresponding to different RAIs 1052. Each column 1056 is designated by a different column index number. For example, the first RAI column 1056 is indexed as RAI_{—}0, the second as RAI_{—}1, and so on for as many columns 1056 as metabolic table 1050 may include.

The reference activity intensities include, in one embodiment, a numeric scale. By way of example, the reference activity intensities may include numbers ranging from one to ten (representing increasing activity intensity). The reference activities may also be represented as a range of letters, colors, and the like. The reference activity intensities may be associated with the vigorousness of an activity. For example, the reference activity intensities may represented by ranges of heart rates or breathing rates.

In one embodiment, metabolic table 1050 includes metabolic loadings 1060. Each metabolic loading 1060 corresponds to a reference activity type 1058 of the reference activity types 1054 and a reference activity intensity 1056 of the reference activity intensities 1052. Each metabolic loading 1060 corresponds to a unique combination of reference activity type 1054 and reference activity intensity 1052. For example, in the column and row arrangement discussed above, one of the reference activity types 1054 of a series of rows 1058 of reference activity types, and one of the reference activity intensities 1052 of a series of columns 1056 of reference activity intensities correspond to a particular metabolic loading 1060. In such an arrangement, each metabolic loading 1060 is identifiable by only one combination of reference activity type 1058 and reference activity intensity 1056.

This concept is illustrated in FIG. 10B. As shown, each metabolic loading 1060 is designated using a two-dimensional index, with the first index dimension corresponding to the row 1058 number and the second index dimension corresponding to the column 1056 number of the metabolic loading 1060. For example, in FIG. 10B, ML_{—}2, 3 has a first dimension index of 2 and a second dimension index of 3. ML_{—}2, 3 corresponds to the row 1058 for RAT_{—}2 and the column 1056 for RAI_{—}3. Any combination of RAT_M and RAI_N may identify a corresponding ML_M, N in metabolic table 1050, where M is any number corresponding to a row 1058 number in metabolic table 1050 and N is any number corresponding to a column 1056 number in metabolic table 1050. By way of example, the reference activity type RAT_{—}3 may be “surfing,” and the reference activity intensity RAI_{—}3 may be “4.” This combination in metabolic table 1050 corresponds to metabolic loading 1060 ML_{—}3, 3, which may, for example, represent 5.0 kcal/kg/hour (a typical value for surfing). In various embodiments, some of the above-described operations are performed by movement monitoring module 802 and some of the operations are performed by a metabolic table module (not shown).

Referring again to method 1000, in various embodiments, the movement is monitored by location tracking (e.g., Global Positioning Satellites (GPS) or by a location-tracking device connected to a network via communication medium 704). The general location of the user, as well as specific movements of the user's body, are monitored. For example, the movement of the user's leg in x, y, and z directions may be monitored (e.g., by an accelerometer or gyroscope). In one embodiment, apparatus 702 receives an instruction regarding which body part is being monitored. For example, apparatus 702 may receive an instruction that the movement of a user's wrist, ankle, head, or torso is being monitored.

In various embodiments, the movement of the user is monitored and a pattern of the movement (pattern) is determined. The pattern may be detected by an accelerometer or gyroscope. The pattern may be a repetition of a motion or a similar motion monitored by the method 1000. For example, the pattern may be geometric shape (e.g., a circle, line, oval) of repeated movement that is monitored. In some cases, the repetition of the motion in the geometric shape is not repeated consistently over time, but is maintained for a substantial proportion of the repetitions of the movement. For instance, one pattern of elliptical motion in a repetitive pattern of ten circular motions may be monitored, and the pattern may be determined to be circular.

In further embodiments, the geometric shape of the pattern of movement is a three dimensional (3-D) shape. To illustrate, the pattern associated with the wrist of a person swimming the butterfly stroke may be monitored and analyzed as a geometric shape in three dimensions. The pattern is complicated, but it may be described in a form that method 1000 can recognize. Such a form may include computer code that describes the spatial relationship of a set of points, along with changes in acceleration forces that are experienced along those points as, for example, a sensor travels through the pattern's trajectory.

In various embodiments, monitoring the pattern includes monitoring the frequency with which the pattern is repeated (or pattern frequency). The pattern frequency may be derived from a repetition period of the pattern (or pattern repetition period). The pattern repetition period may be the length of time elapsing from when a device or sensor passes through a certain point in a pattern and when the device or sensor returns to that point when the pattern is repeated. For example, the sensor may be at point x, y, z at time t_{—}0. The device may then move along the trajectory of the pattern, eventually returning to point x, y, z at time t_{—}1. The pattern repetition period would be the difference between t_{—}1 and t_{—}0 (e.g., measured in seconds). The pattern frequency may be the reciprocal of the pattern repetition period, and may have units of cycles per second. When the pattern repetition period is, for example, two seconds, the pattern frequency would be 0.5 cycles per second.

In some embodiments, various other inputs are used to determine the activity type and activity intensity. For example, monitoring the movement may include monitoring the velocity at which the user is moving (or the user velocity). The user velocity may have units of kilometers per hour. In one embodiment, the user's location information is monitored to determine the user velocity. This may be done by GPS, through communication medium 704, and so on. The user velocity may be distinguished from the speed of the pattern (or pattern speed). For example, the user may be running at a user velocity of 10 km/hour, but the pattern speed of the user's wrist may be 20 km/hour at a given point (e.g., as the wrist moves from behind the user to in front of the user). The pattern speed may be monitored using, for example, an accelerometer or gyroscope.

In one embodiment, the user's altitude is monitored. This may be done, for example, using an altimeter, user location information, information entered by the user, etc. In another embodiment, the impact the user has with an object (e.g., the impact of the user's feet with ground) is monitored. This may be done using an accelerometer or gyroscope. In some cases, the ambient temperature is measured. A group of reference activity types may be associated with bands of ambient temperature. For example, when the ambient temperature is zero degrees Celsius, activities such as skiing, sledding, and ice climbing are appropriate selections for reference activity types, whereas surfing, swimming, and beach volleyball may be inappropriate. The ambient humidity may also be measured (e.g., by a hygrometer). In some cases, pattern duration (i.e., the length of time for which particular movement pattern is sustained) is measured.

Monitoring the movement, in one embodiment, is accomplished using sensors configured to be attached to the user's body. Such sensors may include a gyroscope or accelerometer to detect movement, and a heart-rate sensor, each of which may be embedded in a wristband that a user can wear on the user's wrist or ankle, such as wristband 100. Additionally, various modules and sensors that may be used to perform the above-described operations may be embedded in electronic capsule 200. In various embodiments, the above-described operations are performed by movement monitoring module 802.

Method 1000, in one embodiment, involves determining the user activity type from the set of reference activity types. Once detected, the pattern may be used to determine the user activity type from the set of reference activity types. Each reference activity type is associated with a reference activity type pattern. The user activity type may be determined to be the reference activity type that has a reference activity type pattern that matches the pattern detected by method 1000.

In some cases, the pattern that matches the reference activity type pattern will not be an exact match, but will be substantially similar. In other cases, the patterns will not even be substantially similar, but it may be determined that the patterns match because they are the most similar of any patterns available. For example, the reference activity type may be determined such that the difference between the pattern of movement corresponding to the reference activity type and the pattern of movement is less than a predetermined range or ratio. In one embodiment, the pattern is looked up (for a match) in a reference activity type library. The reference activity type library may be included in metabolic table 1050. For example, the reference type library may include rows in a table such as the RAT rows 1058.

In further embodiments, method 1000 involves using the pattern frequency to determine the user activity type from the set of reference activity types. Several reference activity types may be associated with similar patterns (e.g., because the wrist moves in a similar pattern when running versus walking). In such cases, the pattern frequency may be used to determine the user activity type (e.g., because the pattern frequency for running is higher than the pattern frequency for walking).

Method 1000, in some instances, involves using additional information to determine the user activity type. For example, the pattern for walking may be similar to the pattern for running. The reference activity type of running may be associated with higher user velocities and the reference activity type of walking with lower user velocities. In this way, the velocity measured may be used to distinguish between two reference activity types having similar patterns.

In other embodiments, method 1000 involves monitoring the impact the user has with the ground and determining that, because the impact is larger, the activity type is running rather than walking, for example. If there is no impact, the user activity type may be determined to be cycling (or other activity type where there is no impact). In some cases, the humidity is measured to determine whether the user activity type is a water sport (i.e., whether the activity is being performed in the water). The reference activity types may be narrowed to those that are performed in the water, from which narrowed set of reference activity types the user activity type may be determined. In other cases, the temperature measured is used to determine the user activity type.

Method 1000 may entail instructing the user to confirm the user activity type. In one embodiment, a user interface is provided such that the user can confirm whether a displayed user activity type is correct or select the user activity type from a group of reference activity types.

In further embodiments, a statistical likelihood of choices for user activity type is determined. The possible user activity types are then provided to the user in such a sequence that the most likely user activity type is listed first (and then in descending order of likelihood). For example, it may be determined, based on the pattern, the pattern frequency, the temperature, and so on, that there is an 80% chance the user activity type is running, a 15% chance the user activity type is walking, and a 5% chance the user activity type is dancing. Via a user interface, a list of these possible user activity types may be provided such that the user may select the user activity type the user is performing. In various embodiments, some of the above-described operations are performed by a metabolic loading module.

Method 1000, in some embodiments, also includes determining the user activity intensity from a set of reference activity intensities. The user activity intensity may be determined in a variety of ways. For example, the repetition period (or pattern frequency) and user activity type (UAT) may be associated with a reference activity intensity library to determine the user activity intensity that corresponds to a reference activity intensity. FIG. 10C illustrates one embodiment whereby this aspect of method 1000 is accomplished, including reference activity intensity library 1080. Reference activity intensity library 1080 is organized by rows 1088 of reference activity types 1084 and columns 1086 of pattern frequencies 1082. In FIG. 10C, reference activity library 1080 is implemented in a table. Reference activity library 1080 may, however, be implemented other ways.

In one embodiment, it is determined that, for user activity type 1084 UAT_{—}0 performed at pattern frequency 1082 F_{—}0, the reference activity intensity 1090 is RAI_{—}0, 0. UAT 1084 may, for example, correspond to the reference activity type for running, and a pattern frequency 1082 of 0.5 cycles per second for the user activity type may be determined. In addition, library 1080 may determine (e.g., at operation 1002) that the UAT 1084 of running at a pattern frequency 1082 of 0.5 cycles per second corresponds to an RAI 1090 of five on a scale of ten. In another embodiment, the reference activity intensity is independent of the activity type. For example, the repetition period may be five seconds, and this may correspond to an intensity level of two on a scale of ten regardless of the user activity type.

Reference activity intensity library 1080, in one embodiment, is included in metabolic table 1050. In some cases, the measured repetition period (or pattern frequency) does not correspond exactly to a repetition period for a reference activity intensity in metabolic table 1050. In such cases, the correspondence may be a best-match fit, or may be a fit within a tolerance defined by the user or by a system administrator, for example.

In various embodiments, method 1000 involves supplementing the measurement of pattern frequency to help determine the user activity intensity from the reference activity intensities. For example, if the user activity type is skiing, it may be difficult to determine the user activity intensity because the pattern frequency may be erratic or otherwise immeasurable. In such an example, the user velocity, the user's heart rate, and other indicators (e.g., breathing rate) may be monitored to determine how hard the user is working during the activity. For example, higher heart rate may indicate higher user activity intensity. In a further embodiment, the reference activity intensity is associated with a pattern speed (i.e., the speed or velocity at which the sensor is progressing through the pattern). A higher pattern speed may correspond to a higher user activity intensity.

Method 1000, in one embodiment, determines the user activity type and the user activity intensity by using sensors configured to be attached to the user's body. Such sensors may include, for example, a gyroscope or accelerometer to detect movement, and a heart-rate sensor, each of which may be embedded in a wristband that the user can wear on the user's wrist or ankle, such as wristband 100. Additionally, various sensors and modules that may be used to preform above-described operations of method 1000 may be embedded in electronic capsule 200. In various embodiments, the above-described operations are performed by movement monitoring module 802.

Method 1000, in one embodiment, includes creating and updating a metabolic activity score based on the movement and the user information. Method 1000 may also include determining a metabolic loading associated with the user and the movement. In one embodiment, a duration of the user activity type at a particular user activity intensity (e.g., in seconds, minutes, or hours) is determined.

The metabolic activity score may be created and updated by, for example, multiplying the metabolic loading by the duration of the user activity type at a particular user activity intensity. If the user activity intensity changes, the new metabolic loading (associated with the new user activity intensity) may be multiplied by the duration of the user activity type at the new user activity intensity. In one embodiment, the metabolic activity score is represented as a numerical value. By way of example, the metabolic activity score may be updated by continually supplementing the metabolic activity score as new activities are undertaken by the user. In this way, the metabolic activity score continually increases as the user participates in more and more activities.

Referring again to FIG. 10A, operation 1004 includes detecting a fatigue level. In one embodiment, the fatigue level is the fatigue level of the user. In one embodiment, the fatigue level is a function of recovery. In various embodiments, the fatigue level is described in terms of recovery. The fatigue level may be detected in various ways. In one example, the fatigue level is detected by measuring a heart rate variability (HRV) of the user using logic circuits 240 (discussed above in reference in to FIG. 1). Further, possible representations of the fatigue level are described above (e.g., numerical, descriptive, etc.). When the HRV is more consistent (i.e., steady, consistent amount of time between heartbeats), for example, the fatigue level may be higher. In other words, with a higher fatigue level, the body is typically less fresh and less well-rested. When HRV is more sporadic (i.e., amount of time between heartbeats varies largely), the fatigue level may be lower. In various embodiments, the fatigue level is described in terms of an HRV score.

At operation 1004, HRV may be measured in a number of ways (discussed above in reference in to FIG. 1). Measuring HRV, in one embodiment, involves the combination of wrist biosensor 210 and finger biosensor 220. Wrist biosensor 210 may measure the heartbeat in the wrist of one arm while finger sensor 220 measures the heartbeat in a finger of the hand of the other arm. This combination allows the sensors, which in one embodiment are conductive, to measure an electrical potential through the body. Information about the electrical potential provides cardiac information (e.g., HRV, fatigue level, heart rate information, and so on), and such information may be processed at operation 1004. In other embodiments, the HRV is measured using sensors that monitor other parts of the user's body, rather than the finger and wrist. For example, the sensors may monitor the ankle, leg, arm, or torso.

In one embodiment, at operation 1004, the fatigue level is detected based solely on the HRV measured. The fatigue level, however, may be based on other measurements (e.g., measurements monitored by method 1000). For example, the fatigue level may be based on the amount of sleep that is measured for the previous night, the user activity duration, the user activity type, and the user activity intensity determined for a previous time period (e.g., exercise activity level in the last twenty-four hours).

By way of example, other measurements on which the fatigue level may be based include stress-related activities, such as work and driving in traffic, which may generally cause the user to become fatigued. In some cases, the fatigue level is detected by comparing the HRV measured to a reference HRV. The reference HRV may be based on information gathered from a large number of people from the general public. In another embodiment, the reference HRV is based on past measurements of the user's HRV.

At operation 1004, in one embodiment, the fatigue level is detected once every twenty-four hours. This provides information about the user's fatigue level each day so that the user's activity levels may be directed according to the fatigue level. In various embodiments, the fatigue level is detected more or less often. Using the fatigue level, the user may determine (a) whether or not an activity is necessary (or desirable), (b) the appropriate user activity intensity, and (c) the appropriate user activity duration. For example, in deciding whether to go on a run, or how long to run, the user may want to use operation 1004 to assess the user's current fatigue level. Then, the user may, for example, run for a shorter time if the user is more fatigued, or for a longer time if the user is less fatigued. In some cases, it may be beneficial to detect the fatigue level in the morning, upon the user's waking up. This may provide the user a reference for how the day's activities should proceed.

Referring again to FIG. 10A, operation 1006 involves providing a lifestyle recommendation based on the activity (determined by monitoring the movement at operation 1002), the activity score, and the fatigue level. In one embodiment, the lifestyle recommendation is that the user should be more active, should rest more, or should reduce stress levels generally. For example, if the user is under-fatigued, the user may be getting too much rest or may not be active enough. This may cause a general feeling of lethargy or lack of energy. Using monitored information about various activity and recovery elements—including the nature of the user's activity (e.g., the type and intensity), the activity score (e.g., activity type, intensity, duration, and other factors described above), and the fatigue level—operation 1006 may provide a lifestyle recommendation to optimally blend these activity elements.

In one embodiment, the lifestyle recommendation optimally blends the activity elements by balancing the elements against each other. There may be a natural tension between activity and activity score, on the one hand, and fatigue level, on the other hand. Certain user activity types, user activity intensities, and user activity durations may result in high fatigue levels. The user activity types, intensities, and durations that cause high fatigue levels may be user-specific. For example, a particular user may become highly fatigued by running but not by swimming.

As a further example, another user may become highly fatigued by swimming but not running. Similarly, high user activity intensities may result in disproportionately high fatigue levels that are not beneficial to the user. Because the relationship between these various activity elements is monitored specifically for the user, the lifestyle recommendation may provide a balance tailored to the user's biologically preferred activities (as indicated by the fatigue level). As the user's fatigue level may change day to day, the lifestyle recommendation may also change each day. Additionally, if the user is achieving an optimal fatigue level (not too high and not too low), the lifestyle recommendation may be to simply maintain consistency.

The lifestyle recommendation, in one embodiment, includes a recommended activity. The recommended activity may be a recommended activity type, a recommended activity intensity, a recommended activity duration, or a recommended activity periodicity. By way of example, the lifestyle recommendation may be that the user participate in the user activity type of running only twice per week (recommended activity periodicity). This may be based on a high fatigue level being detected when the user goes running more than twice per week. In one embodiment, when the lifestyle recommendation includes a recommended activity type, the recommended activity type is one of sleep, exercise, work, and recovery.

Another example of the lifestyle recommendation may be that the user keep the user activity intensity less than a particular level (recommended activity intensity). In a further example, the lifestyle recommendation may be that the user not exceed a user activity duration of greater than two hours per day for a group of activity types (e.g., running, swimming, and cycling) or for above a level of activity intensity (recommended activity duration).

Moreover, the lifestyle recommendation may include that the user perform a recommended activity type for a recommended activity duration. For example, the lifestyle recommendation may be that the user get at least six hours of sleep each night. In one embodiment, the lifestyle recommendation includes a recommended activity timing. For example, the lifestyle recommendation may suggest that the user exercise in the morning or that the user go to sleep at a particular time of night. This may be relevant where the sleep monitored at operation 1002 is of poor quality due to a late-night workout, for example.

In one embodiment of method 1000, at operation 1006, the lifestyle recommendation includes a recommended activity score. As described above, the activity score may be a metabolic activity score. In addition, the activity score may include elements of user activity type, user activity intensity, and user activity duration, as well as other elements, such as calories consumed. Providing a recommended activity score, as opposed to a recommended activity type or intensity, as the lifestyle recommendation may thus be a broader recommendation. The recommended activity score may be in the form of a minimum score, maximum score, or a range of scores. For example, the recommended activity score may be that the user should achieve an activity score of between 3,000 and 3,500.

The lifestyle recommendation, in a further embodiment, includes a recommended fatigue level. The recommended fatigue level may be a fatigue level that the user should try to achieve on the following day. For example, the recommended fatigue level may be provided in the morning on Monday, but may be a recommendation that the user's detected fatigue level in the morning on Tuesday be a particular fatigue level. In various embodiments, the recommended fatigue level is within a range of normal fatigue levels for the user.

The recommended fatigue level may vary depending on various factors. For example, the recommended fatigue level may be higher if the user is approaching a period during which the user will be able to rest. This may occur if the user is training for an upcoming event or if the user has a regimented workout schedule. In one embodiment, the lifestyle recommendation is based on an upcoming event. For example, the user may be planning to participate in a triathlon in five days. The lifestyle recommendation may include high intensity activities and high fatigue levels several days before the triathlon, followed by rest, recovery, and lower fatigue levels on the days just before the triathlon.

In one instance, the lifestyle recommendation maintains the fatigue level at an optimal level. The lifestyle recommendation may do this regardless of whether the lifestyle recommendation is in the form of a recommended activity, a recommended activity score, or a recommended fatigue level. By way of example, the optimal fatigue level may be a fatigue level at which the user is neither over-fatigued nor under-fatigued. The fatigue level may be represented on a numerical scale, and the optimal fatigue level may be between 40 and 60, for example. The optimal fatigue level may be tailored to the user, such that the optimal fatigue level is based on the user's previous fatigue levels and actual, recorded performance.

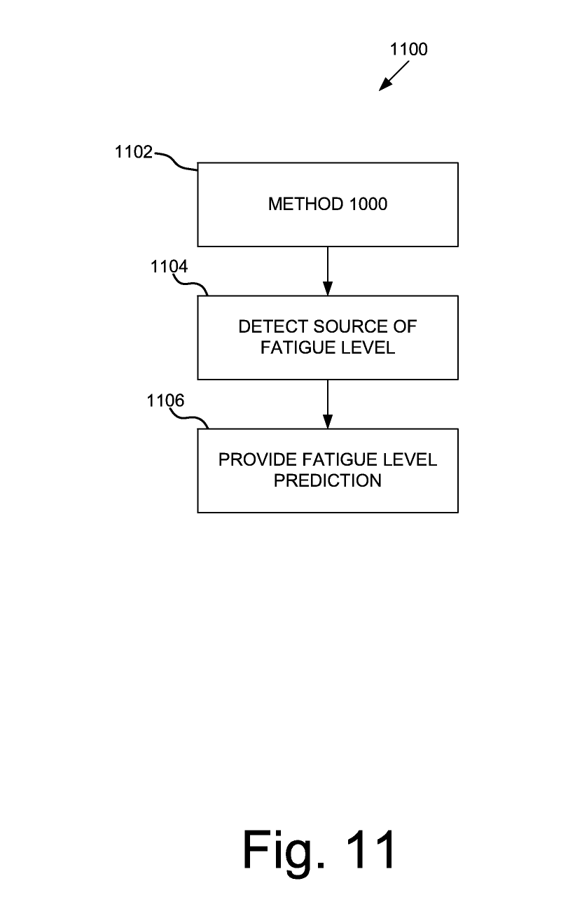

FIG. 11 is an operational flow diagram illustrating example method 1100 for providing a lifestyle recommendation. In one embodiment, apparatus 702, wristband 100, and electronic capsule 200 perform various operations of method 1100. Method 1100, in various embodiments, includes the operations of method 1000.

In one embodiment, at operation 1104, method 1100 involves detecting a source of the fatigue level. The source of the fatigue level may include a set of sources. For example, the source of the fatigue level may be activity, sleep, work, stress, and so on. The source of the fatigue level may be detected by comparing different metrics and eliminating the metrics that are constant. For example, if the user performs roughly the same activities on two different days, but gets far less sleep on one of the days and has a much higher resulting fatigue level, the source of the fatigue is likely the lack of sleep.

In other instances, the user is prompted to provide information regarding the source of the fatigue. For example, the user may be prompted as to whether the user is currently experiencing stress, anxiety, and so on. Depending on the other metrics monitored, this stress or anxiety may be the source of the fatigue. When stress is the source of the fatigue, the lifestyle recommendation may include increased activity. The user may be prompted after following the lifestyle recommendation to determine whether the lifestyle recommendation was effective in reducing the user's stress level. In a further example, if the user's activity levels are higher than typical for the user, the higher activity levels may be detected as the source of the fatigue level.

Referring again to FIG. 11, in one embodiment, method 1100 includes operation 1106, which involves providing a fatigue level prediction based on the lifestyle recommendation. Having monitored the user's activities and detected the fatigue levels (e.g., at operations 1002 and 1004), method 1100 has available information that may serve as the basis for the fatigue level prediction. For example, the fatigue level prediction may be created by extrapolating from the information collected by monitoring the movement and detecting the fatigue level.

Extrapolating from the information, in one case, involves determining that certain combinations of activity (e.g., exercise, rest, and sleep) correspond to certain fatigue levels for the user, as typically monitored. In one embodiment, the fatigue level prediction is provided to the user in graphical form. For example, the fatigue level prediction may be presented as a line graph spanning multiple time periods, such as days or weeks. The fatigue level prediction, in one case, includes a color coding. For example, the fatigue level prediction may be green if the predicted fatigue level is within an optimal zone, yellow if outside but near the optimal zone, and red if well outside the optimal zone.

Moreover, the fatigue level prediction may include multiple activity scenarios. In one embodiment, the fatigue level prediction includes the fatigue level that would occur if the user maintained the status quo (i.e., if the user did not accept the lifestyle recommendation). In such an embodiment, the fatigue level prediction additionally includes the fatigue level that would occur if the user accepted the lifestyle recommendations. By having access to both fatigue level scenarios, the user may be able to better understand how lifestyle choices affect the user's fatigue level and associated performance capacity. In various embodiments, at operation 1106, any number of fatigue level predictions may be provided simultaneously.

In one embodiment, the fatigue level prediction provided at operation 1106 is based on input from the user. The input may function as fatigue level prediction input parameters (or prediction input parameters). By way of example, the user may provide prediction input parameters regarding planned activity, activity score, amounts of sleep, stress levels, and so on. The prediction input parameters may be used to provide the fatigue level prediction. This user-driven fatigue level prediction may allow the user to make informed decisions about the user's lifestyle choices and to make such decisions with an idea of how the decisions may affect the user's fatigue level.

The fatigue level prediction input parameters, in one embodiment, are variables that the user may use to tune the user's predicted fatigue level. By way of example, the user may know that the user is going to be highly stressed for the next three weeks (e.g., due to deadlines at work), which may affect the user's fatigue level. The user may provide the high stress level as one of the prediction input parameters. Then, the user may tune other prediction input parameters, such as activity levels and sleep amounts, to determine a combination of activity and recovery that may help mitigate the user's high stress levels by optimizing the predicted fatigue level.

In various embodiments, at least one of the operations of detecting the source of the fatigue level and providing the fatigue level prediction includes using a sensor configured to be attached to the body of the user.

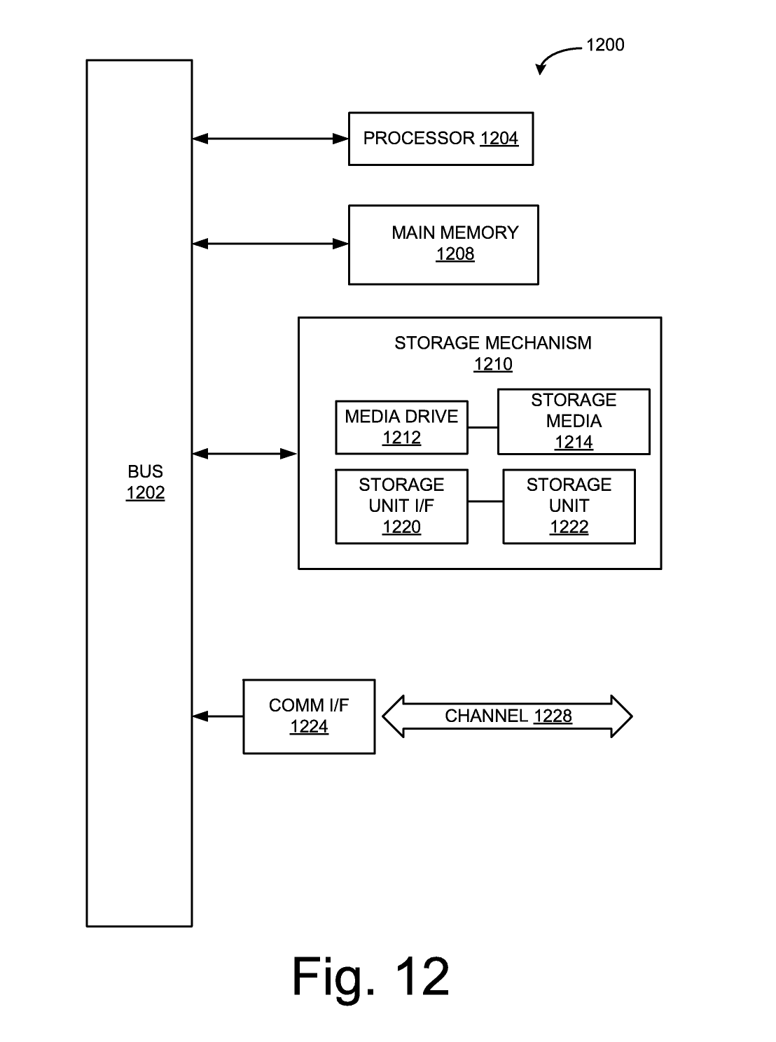

FIG. 12 illustrates an example computing module that may be used to implement various features of the systems and methods disclosed herein. In one embodiment, the computing module includes a processor and a set of computer programs residing on the processor. The set of computer programs is stored on a non-transitory computer readable medium having computer executable program code embodied thereon. The computer executable code is configured to monitor a movement to detect an activity and create an activity score associated with the movement. The computer executable code is further configured to detect a fatigue level. In addition, the computer executable code is configured to provide a lifestyle recommendation based on the activity, the activity score, and the fatigue level.

The example computing module may be used to implement these various features in a variety of ways, as described above with reference to the methods illustrated in FIGS. 10A, 10B, 10C, and, and as will be appreciated by one of ordinary skill in the art.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example-computing module 1200. After reading this description, it will become apparent to a person skilled in the relevant art how to implement the application using other computing modules or architectures.

Referring now to FIG. 12, computing module 1200 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1200 might include, for example, one or more processors, controllers, control modules, or other processing devices, such as a processor 1204. Processor 1204 might be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally.

Computing module 1200 might also include one or more memory modules, simply referred to herein as main memory 1208. For example, preferably random access memory (RAM) or other dynamic memory, might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device coupled to bus 1202 for storing static information and instructions for processor 1204.

The computing module 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid state drive, a magnetic tape drive, an optical disk drive, a CD or DVD drive (R or RW), or other removable or fixed media drive might be provided. Accordingly, storage media 1214 might include, for example, a hard disk, a solid state drive, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing module 1200. Such instrumentalities might include, for example, a fixed or removable storage unit 1222 and a storage interface 1220. Examples of such storage units 1222 and storage interfaces 1220 can include a program cartridge and cartridge interface, a removable memory (for example, a flash memory or other removable memory module) and memory slot, a PCMCIA slot and card, and other fixed or removable storage units 1222 and storage interfaces 1220 that allow software and data to be transferred from the storage unit 1222 to computing module 1200.

Computing module 1200 might also include a communications interface 1224. Communications interface 1224 might be used to allow software and data to be transferred between computing module 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 1200 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. An apparatus for providing a lifestyle recommendation, comprising:
a movement monitoring module that monitors a movement to detect an activity and create an activity score associated with the movement;
a fatigue level module that detects a fatigue level; and
a lifestyle recommendation module that provides a lifestyle recommendation based on the activity, the activity score, and the fatigue level.

2. The apparatus of claim 1, wherein the lifestyle recommendation comprises a recommended activity.

3. The apparatus of claim 1, wherein the lifestyle recommendation comprises a recommended activity score.

4. The apparatus of claim 1, wherein the lifestyle recommendation comprises a recommended fatigue level.

5. The apparatus of claim 2, wherein the recommended activity comprises at least one of a recommended activity type, a recommended activity intensity, a recommended activity duration, a recommended activity time, and a recommended activity periodicity.

6. The apparatus of claim 1, further comprising a fatigue source detection module that detects a source of the fatigue level.

7. The apparatus of claim 1, wherein the lifestyle recommendation maintains the fatigue level at an optimal level.

8. The apparatus of claim 1, further comprising a fatigue level prediction module that provides a fatigue level prediction based on the lifestyle recommendation.

9. The apparatus of claim 8, wherein the fatigue level prediction is based on input from a user.

10. The apparatus of claim 1, wherein at least one of the movement monitoring module, the fatigue level module, and the lifestyle recommendation module is embodied in a wearable sensor.

11. A method for providing a lifestyle recommendation, comprising:
monitoring a movement to detect an activity and create an activity score associated with the movement;
detecting a fatigue level; and
providing a lifestyle recommendation based on the activity, the activity score, and the fatigue level.

12. The method of claim 11, wherein the lifestyle recommendation comprises a recommended activity.

13. The method of claim 11, wherein the lifestyle recommendation comprises a recommended activity score.

14. The method of claim 11, wherein the lifestyle recommendation comprises a recommended fatigue level.

15. The method of claim 11, further comprising detecting a source of the fatigue level.

16. The method of claim 11, wherein the lifestyle recommendation maintains the fatigue level at an optimal level.

17. The method of claim 11, further comprising providing a fatigue level prediction based on the lifestyle recommendation.

18. The method of claim 17, wherein the fatigue level prediction is based on input from a user.

19. The method of claim 11, wherein at least one of the operations of monitoring the movement, detecting the fatigue level, and providing the lifestyle recommendation comprises using a sensor configured to be attached to the body of a user.

20. A system for providing a lifestyle recommendation, comprising:
a processor; and
at least one computer program residing on the processor;
wherein the computer program is stored on a non-transitory computer readable medium having computer executable program code embodied thereon, the computer executable program code configured to:
monitor a movement to detect an activity and create an activity score associated with the movement;
detect a fatigue level; and
provide a lifestyle recommendation based on the activity, the activity score, and the fatigue level.
